(19) United States
(12) Patent Application Publication
(10) Pub. No.: US 2023/0252268 A1
(43) Pub. Date: Aug. 10, 2023

(54) PREDICTING STATES OF A TEST ENTITY

(71) Applicant: International Business Machines Corporation, Armonk, NY (US)

(72) Inventors: Andrea Giovannini, Zurich (CH); Matteo Manica, Zurich (CH)

(21) Appl. No.: 17/665,848

(22) Filed: Feb. 7, 2022

(51) Int. Cl. G06N 3/04; G06N 3/08

(52) U.S. Cl. CPC G06N 3/0454; G06N 3/088

(57) ABSTRACT

An approach for predicting a state of a test entity may be provided. The approach may include providing a test graph, corresponding to the test entity, and a conditional generative model, based on a graph neural network. The test graph may have a hybrid structure, which may be a static graph and a dynamic graph. The static graph may include a reference vertex associated with an entity. The reference vertex can be connected to peripheral vertices associated with permanent attributes of the entity. The dynamic graph may be connected to the reference vertex and include chronological vertices associated with transient attributes. The chronological vertices are chronologically ordered via oriented chronological edges. The approach may predict a next chronological state of the test graph based on applying the test graph to the conditional generative model.

### BACKGROUND OF THE INVENTION

The invention relates in general to the field of predicting a next chronological state of a test entity. In particular, conditional generative models based on graph neural networks.

An electronic health record (EHR) contains health information about a patient or a group of patients. This information is electronically stored in a digital format. EHRs may include various types of medically relevant data, including medical history data, medication, allergies, laboratory test results, immunization status, radiology images, vital signs, and personal statistics such as age and weight. EHR datasets are being populated and updated in many hospitals.

The ever growing EHR datasets lend themselves well to the application of statistical methods requiring large amounts of data. EHR data has been used to generate knowledge bases and train machine learning models. In particular, the generated knowledge bases can be used for inferencing purposes using a fully explainable approach.

Knowledge base systems are used to store both structured and unstructured information. A knowledge graph is a knowledge base relying on a graph-structured model (or topology) to integrate data. Graphs are data structures, which adequately capture the relational structure of many real-world systems.

Machine learning often relies on artificial neural networks (ANNs), which are computational models inspired by biological neural networks in human or animal brains. Such systems progressively and autonomously learn tasks by means through sample data. Artificial neural networks have been applied to numerous use cases such as, speech recognition, text processing and computer vision. Many types of neural networks have been developed, including feedforward neural networks, multilayer perceptrons, deep neural networks, and convolutional neural networks. In general, machine learning models can be designed to predict an outcome based on a set of input features.

Graph neural networks (GNNs) process data represented by graph data structures. Graph neural networks can be to express probabilistic dependencies among a graph's nodes and edges, to learn distributions over any arbitrary graph. Three main types of deep generative models are known, which are: variational autoencoders, generative adversarial networks, and deep auto-regressive models.

### SUMMARY

Embodiments of the present disclosure include a computer-implemented method, computer program product, and a system for predicting a state of a test entity. Embodiments may include providing a test graph, wherein the test graph corresponds to a test entity and the test graph has a hybrid structure comprising a static graph that includes a reference vertex associated with an entity, and a dynamic graph connected to the reference vertex. Embodiments may further include applying the test graph to a conditional generative model, wherein the conditional generative model has a graph neural network structure. Embodiments may further include, predicting a first chronological state for the test graph based on the application of the test graph to the conditional generative model.

The above summary is not intended to describe each illustrated embodiment of every implementation of the present disclosure. Rather, numerous embodiments described further below may fall within the scope and spirit of the present disclosure.

### BRIEF DESCRIPTION OF THE DRAWINGS

FIG. 1 is a diagram illustrating a specialist interacting with a computerized system, in order to predict future states of a graph corresponding to a medical patient, in accordance with an embodiment of the invention.

FIGS. 2A, 2B, and 2C are diagrams illustrating the construction of a graph having a hybrid structure (involving both a static graph and a dynamic graph), in accordance with an embodiment of the invention.

FIG. 3 is a flowchart illustrating high-level steps of a method of predicting future states of a graph corresponding to test entity, in accordance with an embodiment of the invention.

FIG. 4 is a diagram illustrating the training of a cognitive model based on a graph variational autoencoder, in accordance with an embodiment of the invention.

FIGS. 5 and 6 are diagrams illustrating how information can be processed to train a graph variational autoencoder, in accordance with an embodiment of the invention.

FIG. 6 is a diagram illustrating how to perform inferences, in accordance with an embodiment of the invention.

FIG. 7 schematically represents an exemplary computing system suited for implementing actions or operations of the invention, in accordance with an embodiment of the invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION OF EMBODIMENTS OF THE INVENTION

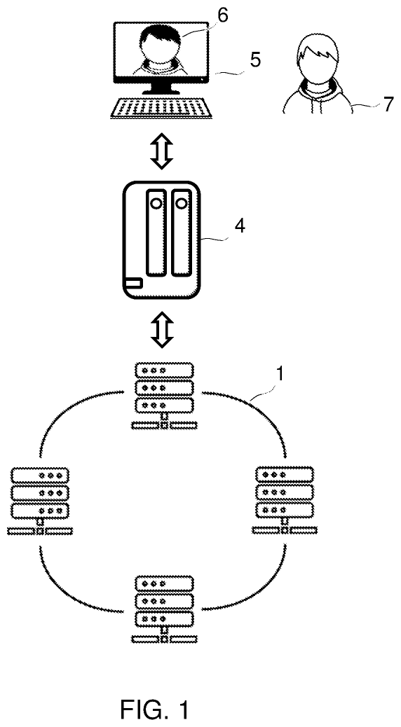

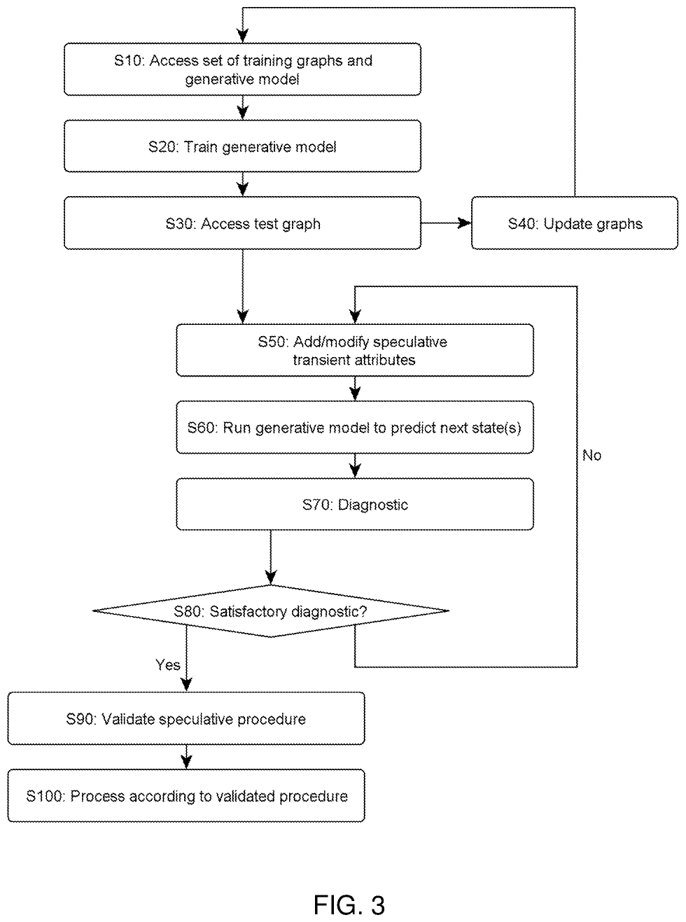

In reference to FIGS. 1-3, a first aspect of the invention is now described. This aspect concerns a computer-implemented method. Note, the present method and its variants are collectively referred to as the “present methods”. All references Sn refer to method steps of the flowchart of FIG. 3, while numeral references pertain to devices, components, and concepts involved in the present invention.

Embodiments of the present invention can predict a state of a graph corresponding to a test entity, such as a medical patient 6 (FIG. 1). Embodiments, may utilize a conditional generative model, based on a graph neural network. The method can include loading (step S10 in FIG. 3) a test graph corresponding to the test entity 6, as well as a trained cognitive model, with a view to predicting (step S60) a next chronological state of the test graph. The graphs may have a specific structure to train the conditional generative model.

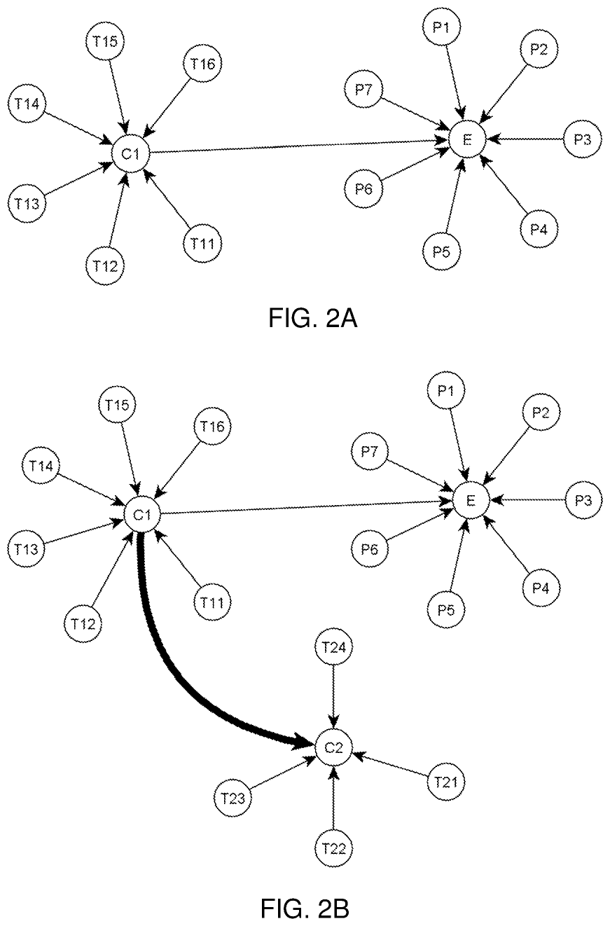

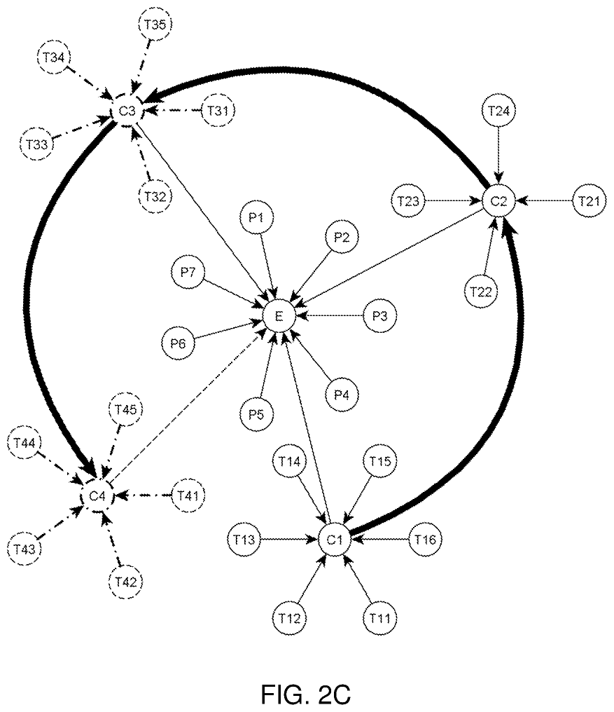

The test graph and the training graphs can have a hybrid structure. The hybrid structure can be a static graph and a dynamic graph. This hybrid structure is apparent in FIGS. 2A-2C, which illustrates the progressive construction of a graph, as in embodiments. The static graph includes a reference vertex E and peripheral vertices P1-P7. The reference vertex E is associated with a given entity. The reference vertex E is connected to peripheral vertices P1-P7, which are associated with permanent attributes of this entity. Permanent attributes are lasting information, in other words, information that is assumed to remain unchanged for a long time, possibly indefinitely, or at least, substantially longer than information attached to the dynamic graph.

The dynamic graph is connected to the reference vertex E. The dynamic graph includes chronological vertices Ci (where i=1, 2, 3, 4), which are associated with transient attributes, preferably by way of vertices Tij (where j=1, 2, . . . ) connected to the chronological vertices Ci, as assumed in FIGS. 2A-2C. The dynamic graph captures chronological information, as opposed to the permanent information attached to the static graph. Note, time information too can be encoded as attributes, e.g., by way of corresponding vertices linked to respective chronological vertices. The chronological vertices Ci are chronologically ordered thanks to oriented chronological edges, represented as bold curved arrows in FIGS. 2B and 2C. Of course, the depicted graphs are purposely simple, for the sake of depiction. In practice, the graphs used for training may include numerous (e.g., 10s, 100s, 1000s, etc.) chronological vertices, each associated with several peripheral vertices.

The oriented chronological edges differ from the other type of edges, represented as the thin arrows in FIGS. 2A-2C. Two types of edges are used, which can be referred to as “atemporal edges” and “chronological edges”. The atemporal edges are oriented edges, which are used to connect vertices E and Pk, as well as vertices Tij and Ci, and vertices Ci and E. Such edges do not imply a chronological order. By contrast, the chronological edges are used to chronologically order the chronological vertices. By convention, the atemporal edges are oriented toward the entity E in FIGS. 2A-2C. However, a different convention may be used.

The cognitive model is a temporal-aware, graph generative model, where transient attributes of the training graphs condition the trained model. A next chronological state of a test graph is predicted S60 by running the conditional generative model on the test graph. Running the conditional generative model on the test graph means that the model is executed for inferencing purposes, using the test graph (or information extracted from the test graph) as input.

The outcome of this inferencing step S60 is a next state of the test graph. That is, the test graph (which is in a given state) is used as input to predict a next state of the test graph. This differs from usual machine learning methods. That is, inferences made by usual classifiers or predictors depend on labels used to train the model. For example, a set of labelled examples of the form {{example 1, label 1}, {example 2, label 2}, . . . } are used to train a model, for it to subsequently perform predictions or classifications based on new examples (without any associated label). I.e., the outcome of such predictions or classifications are new labels inferred for the new examples. Thus, the type of the results inferred (the new labels) differs from the type of input data (the new examples). For example, one may train a model to predict a likelihood or chance for medical patients to develop a particular disease based on a dataset containing a list of patients with their age, gender, and various health records. In the present case, however, the predictions concern potential future states of the entity and are performed on the basis of previous states of this entity. Such states are determined by the components of the graphs, i.e., the vertices and edges, and by the chronological vertices and associated information.

In an embodiment, a conditional generative model based on graph neural network may be utilized to generate the inference and predict the next state of the test graph. An embodiment of the invention may rely on a graph generative model, which, by construction, is conditional on transient attributes of the training graphs. The hybrid structure of the graphs used to train the model to perform inferences makes it possible to obtain next state or chronological predictions. In an embodiment of the invention, predictions can be utilized by specialists, (e.g., physicians, veterinarians, engineers, etc.) to generate treatment plans or preempt issues. A possible explanation is that the hybrid structure of the graphs allows the cognitive model to correlate the successive chronological data more easily, not only with itself but also with the static anchors (the permanent information), as the present inventors came to conclude after intensive tests based on large realistic datasets.

The proposed method can advantageously be applied to medical patients, by exploiting data in electronic health records (EHRs), with a view to predicting potential future states of such entities. In that case, the entity node E of the hybrid structure corresponds to a patient 6, while the chronological vertices Ci and associated attributes of the hybrid structure are built from data extracted from EHRs. For example, the chronological vertices Ci may correspond to hospital encounters, while the associated transient attributes may capture findings of the respective encounters. Such information can easily be extracted from EHRs, digitally. In particular, some (at least) of the chronological vertices Ci and the associated transient attributes may capture data related to a medical treatment or a medical procedure.

In variants, the present approach is applied to other types of entities, such as plants (e.g., production sites) or other complex systems, such as information technology systems. For example, an entity of the hybrid structure may correspond to a computerized system, while the chronological vertices Ci and associated attributes may capture information based on records obtained by monitoring similar computerized systems. In particular, the invention is applicable to transaction networks and IT support. Various other applications can be contemplated. The following, however, mostly assumes applications to medical data, for the sake of illustration.

In practice, the graphs are populated and updated thanks to inputs provided by a specialist 7, using techniques known from knowledge bases and knowledge graphs. For example, the specialist 7 may be a physician, while the target entity 6 may be a medical patient, as assumed in FIG. 1. In that case, and as seen in FIG. 2A, the reference vertex E of static graph corresponds to the patient. The reference vertex E is connected to peripheral vertices P1-P7 via atemporal directed edges, where the peripheral vertices capture permanent information about the patient (e.g., age, gender, body mass, chronic condition, etc.). A single chronological vertex C1 is seen in FIG. 2A (corresponding to a given encounter), which is associated with transient events or facts captured by peripheral vertices T11-T16. The transient information relates to findings of the encounters. The vertex C1 is connected to the reference vertex E via an atemporal directed edge.

As illustrated in FIGS. 2B and 2C, such a graph may be updated S40 by adding chronological vertices Ci corresponding to actual encounters. Such vertices Ci are associated with transient properties (i.e., corresponding to findings of the encounters). These properties are captured by vertices Tij, which are connected to the chronological vertices Ci. Starting from the initial graph of FIG. 2A (which includes a single chronological vertex C1), two additional chronological vertices C2, C3 may possibly be added over time, e.g., thanks to corresponding inputs by the specialist 7. The added vertices C2, C3 are chronologically ordered thanks to oriented chronological edges, each extending from the previous chronological vertex. Again, the added chronological vertices C2, C3 correspond to transient events. Each of the added chronological vertices is further connected to the reference vertex E via atemporal directed edges. Beyond their chronological ordering, the vertices Ci may further be associated with precise timestamps. The latter can for instance be easily captured as vertices that are connected to the respective chronological vertices. More generally, the proposed graph structure makes it easy to attach properties to each chronological vertex and is flexible. Any property can be integrated by way of vertices.

In the examples of FIGS. 2A-2C, the permanent information is captured by the peripheral vertices Pk, which connect to the entity vertex E. Similarly, each of the chronological vertices Ci is connected to peripheral vertices Tij, which capture the transient attributes, i.e., the transient information. In addition, each chronological vertex connects to the entity vertex E, to make the structure a single graph. In variants, more compact graph structures may be contemplated, where the transient properties may be directly included in the chronological vertices, rather than being connected to them using directed edges. However, decoupling the various properties by way of peripheral nodes Pk, Tij connected to the entity vertex and the chronological vertices allows better results to be achieved, as noted earlier.

Of particular advantage is that the proposed hybrid graph structure lends itself well to state predictions based on intermediate speculations (or assumptions). That is, intermediate states and/or transient attributes may possibly be speculated (e.g., thanks to automated or human inputs), which correspond to potential future events, as opposed to actual events that already occurred. The subsequent predictions S60 would then make it possible to simulate or test the potential consequences of such speculations. In particular, this can be used to simulate the potential effects of possible medical treatments or procedures.

Namely, a specialist 7 or an automated procedure may propose to perform certain acts, procedures, treatments, etc., which can be translated into transient attributes. Such attributes are referred as “speculative” attributes herein. That is, such attributes relate to conjectural information. They relate to potential facts, which have not occurred yet and may possibly never occur, unless a specialist or an automated procedure later decides to validate them. The speculative attributes may for instance include information as to a potential medical treatment or procedure (e.g., medication, and specific amount, number, and frequency of doses thereof). The speculative transient attributes can for instance be regarded as potential vertices, which may later be possibly connected to a chronological vertex in the test graph.

Next, the present methods may access S50 the speculative transient attributes obtained, with a view to performing predictions S60, as seen in the flowchart of FIG. 3. That is, a next chronological state of the test graph can be predicted S60 by running the conditional generative model based on the test graph, and the speculative transient attributes accessed. Note, the prediction performed at step S60 may possibly lead to predict several successive chronological states, depending on how the model was trained and the speculative information considered. The cognitive model attempts to predict a next chronological vertex, or several next chronological vertices, in accordance with the speculative transient attributes accessed, or some of these attributes.

In an embodiment, the model may attempt to connect a next chronological vertex (e.g., corresponding to an encounter) with vertices corresponding to the speculated attributes. For example, the model may further attempt to complete missing vertices. The missing vertices may for example correspond to timestamps associated with the inferred chronological vertices and/or to missing inputs, i.e., transient attributes that were not forming part of the speculated attributes. Each of the predicted chronological vertices defines, together with the associated information (the connected transient vertices), a further chronological state of the graph. To sum up, one or more a chronological states of the graph can be predicted S60 based on speculative information entered automatically or thanks to human inputs.

The further state prediction takes into account the added attributes, which amounts to testing a potential outcome of the speculative information added. In other words, one may try to predict potential, longer-term future states of the target entity by proposing speculative shorter-term states (or part thereof), which amounts to simulating potential outcomes of such propositions. This can be used to simulate the potential effects of possible medical treatments or procedures. Such simulations may be performed automatically or semi-automatically, e.g., according to some predefined treatment or procedure protocol for medical patients.

For example, as illustrated in FIG. 2C, speculative nodes T31-T35 and T41-T45 may be created based on inputs from a specialist 7. The created nodes do not define a further state of the system yet, because they are not connected and not ordered in time. The prediction made at step S60 may, for example: (i) create two additional chronological vertices C3 and C4, (ii) order the two additional chronological vertices predicted, and (iii) connect two distinct sets of the added nodes T31-T35 and T41-T45 to respective vertices C3 and C4, in accordance with representations learned by the cognitive model. The indices 31-35, 41-45 used to denote the speculative nodes T31-T35 and T41-T45 correspond to indices as would be obtained after step S60. Before the inference step S60, the speculative nodes only exist in the form of conjectural data; they do not form vertices yet and are not attached to any chronological vertex. Thus, they cannot be indexed according to the chronological vertices yet.

The procedure proposed above may be performed iteratively (i.e., as a trial-and-error method), as suggested by the loop (S50-S80: No) in FIG. 3. For example, after S60 predicting a next chronological state, one may want to modify the speculative transient attributes, e.g., in view of the last prediction obtained. Thus, the algorithm may then access S50 a modified version of the speculative transient attributes and perform S60 a further prediction for the next chronological state(s) of the test graph, based on the test graph as initially loaded and the modified version of the speculative transient attributes. The next chronological vertex/vertices predicted will thus correspond to the modified version of the speculative transient attributes.

The proposed iterative process may include an analysis or diagnostic S70 of the next chronological state(s) predicted, as seen in FIG. 3. The outcome of this analysis may possibly be unconvincing, inconclusive, or somehow not satisfactory (S80: No). In turn, the specialist 7 may try to modify S50 the previously added speculative attributes, to modify the predictions S60, and so on. Once the analysis outcome is satisfactory (S80: Yes), the specialist 7 may consider acting S100 on the test entity 6 in accordance S90 with the last prediction and the analysis outcome. For example, one may act on the test entity to alter a behavior or a functioning thereof (e.g., one may subject a patient to a medical treatment or procedure in accordance with results of the prediction).

According to the above embodiments, one or more transient attributes are speculated (i.e., conjectured), in order to predict one or more next states of the test graph, e.g., by inferring one or more next chronological vertices and connecting the latter to vertices capturing the speculated attributes, this inference may be achieved using a neural network with two input channels (discussed further below).

In an embodiment, one may speculate on the chronological vertices themselves, to predict further chronological vertices. This may be the case where the transient information is forming part of the chronological vertices (directly), rather than being attached by way of connected vertices. The predictions could be made on the basis of added chronological vertices, which directly include the associated properties. Namely, one may first modify the test graph (at step S50) by adding one or more speculative chronological vertices (associated with speculative transient information) to it, then chronologically order S50 the added vertices thanks to oriented chronological edges, and finally predict S60 further chronological states of the test graph by running the conditional generative model on the modified test graph. In that case, the further state prediction takes into account both the added chronological vertices and associated properties, to test a potential outcome of the speculative information added. Again, this may be performed iteratively. In other words, one may further modify S50 the test graph by modifying the speculative chronological vertices previously added and/or the associated (speculative) information, and then predict S60 an additional chronological state of the test graph by running the cognitive model on the further modified test graph.

More generally, various approaches can be contemplated to simulate long-term future states of the target entity. For example, simulate a potential outcome of a medical treatment or procedure for patient 6.

In another embodiment, the method may speculate transient attributes and accordingly predict next states of the graph, as assumed in the following example. The following may include preferred cognitive models and preferred approaches to train the models and perform inferences with said models.

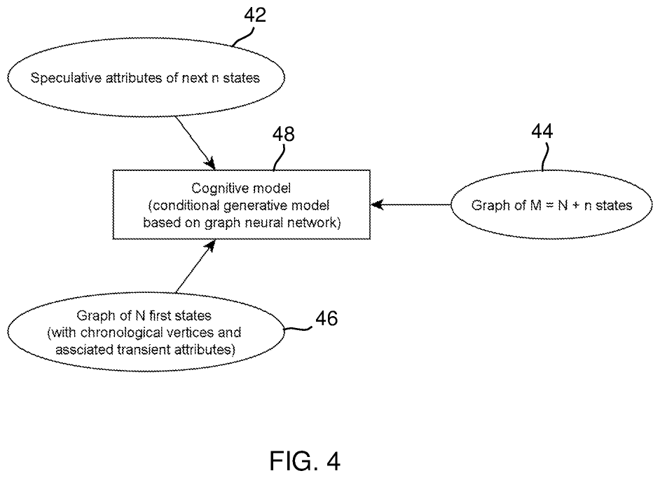

For example, cognitive model 48 (FIG. 4) may be trained based on a set of training graphs, during a preliminary phase S20, prior to performing inferences at step S60. The aim of the training step S20 is for 48 model to learn temporal evolutions of chronological states of the training graphs. The subsequent inferences performed at step S60 can accordingly be regarded as reflecting the statistically normal responses of the trained model. Note, model 48 may possibly be trained recurrently, see steps S40-S10-S20, based on updated versions of the training graphs.

Conditional generative model 48 is preferably implemented as a variational autoencoder by the graph neural network. For example, the graph neural network can be a graph variational autoencoder. As opposed to a usual encoder, a variational encoder compresses the input information into a constrained, multivariate latent distribution. Although the mathematical formulation is different, the architecture remains similar to that of a usual autoencoder. In the following, the graph variational autoencoder is sometimes referred to as a graph autoencoder or, even, an autoencoder, for simplicity. Other embodiments of the present invention may utilize concepts of conditional generative variational autoencoders (CGVAEs), graph transformation policy networks (GTPNs), normalizing flows (NFs), an/or deep Q-learning networks (DQNs), yet suitably adapted for the present purposes.

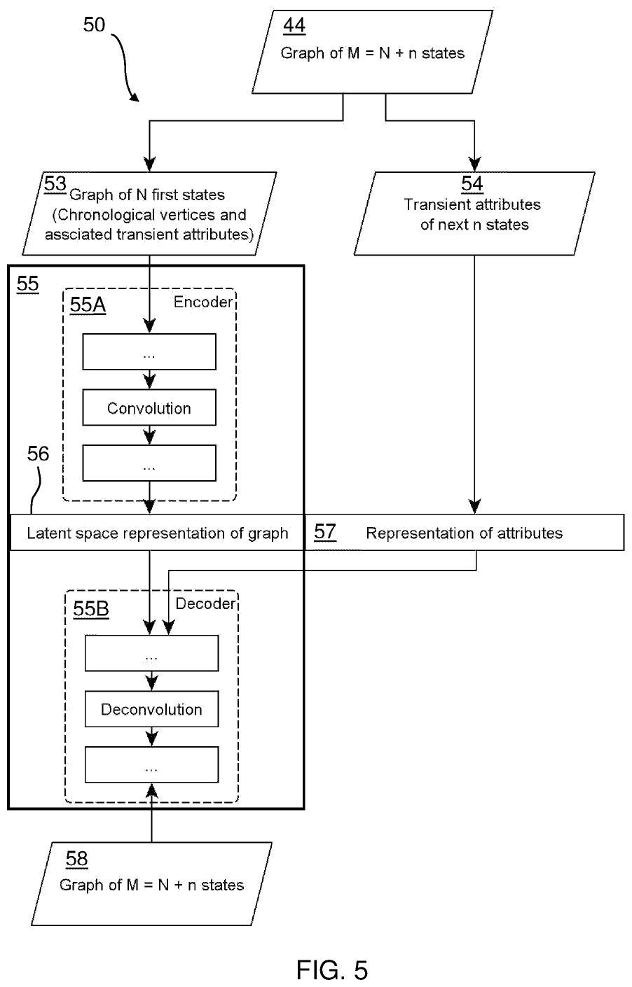

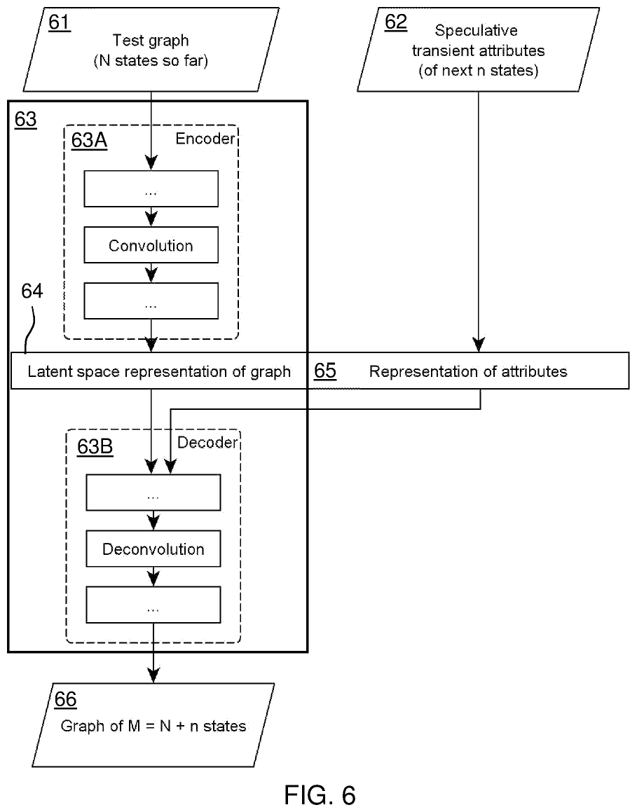

As schematically depicted in FIG. 5 or 6, the architecture of the cognitive model may include input channels, into which distinct sets of data are separately fed (step 53 and 54). The model is trained S20 in accordance with a set of training graphs. Each graph of the training set is accessed to extract distinct sets of data. Training graph 44 is assumed to span a full chronological sequence, which is decomposed into two contiguous chronological sequences, (i.e., a first sequence followed by a second sequence). The graphs can span different chronological sequences. The algorithm may extract data from each of the first and second sequences and, thus, for each training graph. The extracted data are logically referred to as “first data” and “second data”. The first data relate to both the chronological vertices and the associated transient attributes, corresponding to the first sequence, while the second data relate to the sole transient attributes associated with the chronological vertices corresponding to the second sequence.

As shown in FIG. 5, the first data and the second data are separately fed into first input channel 53 and the second input channel 54, respectively. Graph variational autoencoder may include two input channels (53 and 54) receiving two feeds, where input channel 53 receives all relevant data corresponding to a first time period, while input channel 54 receives the sole transient attributes of the following time period. Meanwhile, autoencoder 55 can be connected to the second time period, as schematically depicted in FIG. 4 for a single training graph, in order for it to learn to correctly predict the chronological vertices corresponding. In practice, however, the aim of the training process is for cognitive model 48 to learn how to best reconstruct temporal evolutions based on a plurality of training graphs. Typically, the number of training graphs needed for training purposes is on the order of 1,000, 10,000 or more.

As shown in FIG. 5, autoencoder 55 includes an encoder part 55A and a decoder 55B, where decoder 55B is connected to the encoder 55A. Encoder 55A is designed to encode input data in latent space representation 56, i.e., in an inner layer block (as shown in FIG. 5), while the decoder is designed to decode data from the inner layer block. Encoder 55A may include convolutional layer blocks connected by the first input channel 53, while the decoder 55B may comprise deconvolution layer blocks connected to encoder 55A.

In the present context, first input channel 53 may advantageously connect to encoder 55A, while the second channel 54 may directly connect to the inner layer block 57. Second channel 54 may for instance directly concatenate a representation of the transient attributes 57 extracted from the second time period with the latent information obtained from the encoder 55A, in the inner layer block. This representation of the transient attributes may be obtained using any suitable feature extractor, which produces a vector from the input attributes. The components of this vector can be concatenated with the latent representation obtained via the encoder, in an inner layer of the autoencoder. Thus, the second data condition the latent space of the autoencoder.

For instance, as depicted in FIGS. 4 and 5, data capturing a full graph of M=N+n chronological vertices 44 can be extracted as follows. A first data may be extracted from the N chronological vertices (N≥2) and the associated transient attributes. Such data corresponds to a first period, i.e., the period spanned by the N chronological vertices. Second data may be extracted from the sole transient attributes associated with the next n vertices (where n≥1). The second data extracted may be subject to some feature extraction, as noted above, so as to arrive at a convenient representation of the extracted data, which can then be directly fed to the latent space code, e.g., by concatenation, as shown in FIG. 5. Likewise, upstream layers of the encoder convert the input graph data into an embedding vector. Meanwhile, the autoencoder may be exposed in output to the full graph (spanning the M=N+n nodes), as also shown in FIG. 4, for the model to learn how to recreate the output graph based on the partial information fed in input. Note, the training process is illustrated in respect of a single full graph in FIGS. 4 and 5. However, in reality, this process is performed for as many training graphs as possible, using training techniques for graph variational autoencoders that are known per se.

For example, exposing a graph with N+1 states to the decoder 55B (i.e., n=1), makes it possible for the model to learn how to reconstruct features of the N+1^{th} states. The same can be made for two subsequent states (n=2), etc. Several other variants can be contemplated, the training data permitting. In another example, one may first build a graph from the first N states and separately ingest all data relevant to the first N states and second data corresponding to attributes extracted from the N+1th state, to finally expose a graph of N+2 states to the decoder output, for the model to learn to (i) reconstruct features of the N+1th state and (ii) infer features of the N+2^{th} state. Thus, the model can potentially learn several missing chronological steps, as well as missing properties (attributes) and how to connect such attributes to form subsequent states.

Cognitive model 48 may be trained (i.e, in S20) based on a loss function designed so as to impose a minimal smoothness of time variation of the predicted states. In other words, given the temporal nature of the data, one may include an additional term in the loss function that forces the graph to vary smoothly over time, with a penalization term dependent on the elapsed time (i.e., short times maps to small variations in the graph). For example, the loss function may be formulated by introducing a reconstruction term and a Kullback-Leibler divergence term. The reconstruction term can for instance be formulated by different transformations of the adjacency matrix and the incidence matrix or the graph are reconstructed with different weights.

A trained model can be used to predict the next chronological state (i.e., in S60), as illustrated in FIG. 6. The architecture of the cognitive model 48 is the same as in FIG. 5. In this example, a next chronological state of a test graph is predicted S60 by extracting data from the test graph 61 and feeding the data, as well as additional transient data 62, into respective input channels of the model. The first data relates to both the chronological vertices (and the associated transient attributes) of the test graph considered (i.e., as at step S30). The test graph spans a given period. This time, the second data is not extracted from a graph but from speculative transient attributes, e.g., as formed based on inputs from a specialist 7. The speculative data is accessed at step S50, as described earlier. The two datasets are then separately fed into the first and second input channels, for the trained 63 autoencoder to predict the next chronological state(s) (e.g., by inferring a next chronological vertex corresponding to the speculative transient attributes). An inferred graph is obtained in output; the output graph corresponds to the input graph, complemented by one or more chronological vertices connected to peripheral vertices capturing at least some of the speculative transient attributes. In turn, the specialist can analyze S70 the output graph and decide S90 to act on the underlying entity E, should the outcome of the analysis be satisfactory (S80: Yes).

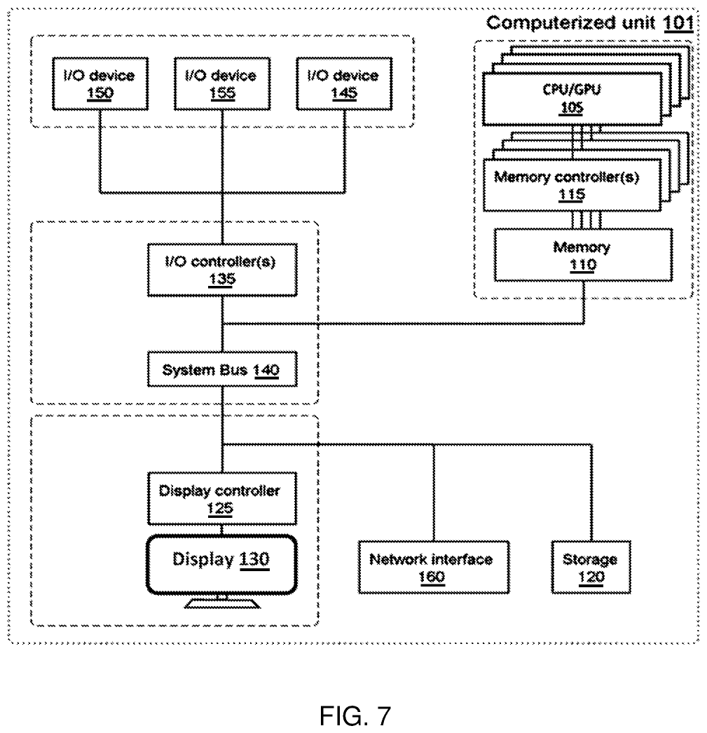

Next, according to another aspect, the invention can be embodied as a computer program product for predicting a state of a test entity 6. The computer program product comprises a computer readable storage medium having program instructions embodied therewith. Such instructions typically form a software, e.g., stored in the storage 120 of a computerized unit 101 such as shown in FIG. 7. The program instructions can be executed by processing means 105 of such a unit 101 to cause the latter to perform steps according to the present methods.

Note, the computerized system used to perform the steps of the present methods may include one or more computerized units 101 such as shown in FIG. 7. That is, the steps of the present methods may possibly be performed by a single computer or, in variants, via a network of interconnected computerized units, (e.g., a cloud computing system). For example, nodes of the cloud computing system may store and deploy resources, so as to provide cloud services for users 7, where such services may include services for navigating graphs, training cognitive models, and performing inferences with the trained models, so as to predict future states of graphs corresponding to test entities. Additional aspects of computerized systems and computer program products are described in further detail below.

Embodiments may leverage graphs to predict a future patient status. Any treatment, intervention, or update, of the patient status would automatically translate into a change in the connectivity and nodes of a patient's graph, which can be exploited to model the temporal evolution of the patient (including disease prognosis) as a dynamically changing graph.

This application may rely on a combination of an explicit temporal modelling of the data samples, which are translated into graphs, and graph neural networks. The algorithm learns how to mimic this dynamic evolution from EHRs, using a generative model based on a graph neural network, which is a graph variational autoencoder. This makes it possible to model a patient condition at an unprecedented resolution and account both for the patient history and prior medical knowledge with a graph representation. The output of inferences made by the model is a new state (or new states) of the patient, which may represent the effect of a given change in, e.g., her/his regimen, therapies, or a set of medical features.

An example of application is depicted in FIG. 1. A specialist 7 enters medical data related to a patient 6 in a personnel computer 5, in order to update an EHR of this patient. The software used by the specialist 7 allows the EHR to be represented as a knowledge graph, which the physician can navigate, to explore the medical history of the patient. This software further allows the specialist 7 to access a cloud service provided via a gateway 4. The cloud computing system 1 enable resources allowing to train cognitive models based on EHRs. The cloud 1 may allow the specialist 7 to use a trained cognitive model to predict future chronological states of this graph. If necessary, the specialist 7 may test and refine certain attributes (e.g., of a treatment or procedure) and predict subsequent states of the graph, in order to identify an optimal treatment or procedure, as explained in the next sub-section.

FIG. 3 shows a high-level flow of operations according to preferred embodiments. First, the method accesses (i.e., loads) a set of training graphs and a generative model, at step S10. The method subsequently trains S20 the generative model based on the training sets, as described in section 1 in reference to FIGS. 4-5. At step S30, a given test graph (corresponding to patient 6) is loaded. The accessed graph may possibly come to be updated S40 over time, based on most recent records, which may subsequently cause to retrain S20 the model. At step S50, specialist 7 may speculate transient attributes (e.g., properties of and facts associated with a given treatment), based on which the trained model is run S60 to predict a next state of the patient. The algorithm outputs a graph capturing this new state; the graph may show an additional chronological vertex, which is connected by peripheral vertices capturing some of the previously formulated attributes. In addition, some missing vertices can be inferred, which provides additional information as to the potential treatment. Specialist 7 performs a diagnostic at step S70, based on the predicted state. If the diagnostic is not fully satisfactory yet (S80: No), the specialist 7 may refine the speculative attributes. This process can be iteratively repeated until a satisfactory diagnostic is achieved. Once a satisfactory diagnostic has been obtained (S80: Yes), the specialist 7 may elaborate S90 details of a procedure in accordance with the refined attributes and eventually start S100 a treatment (subject to the approval of the patient) according to this procedure.

Computerized systems and devices can be suitably designed for implementing embodiments of the present invention as described herein. In that respect, it should be appreciated that the methods described herein are largely non-interactive and automated. In exemplary embodiments, the methods described herein can be implemented either in an interactive, a partly-interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented via virtual machines and/or general-purpose digital computers, such as personal computers, workstations, etc.

For instance, the present methods may be performed using one or more computerized units 101 (e.g., general- or specific-purpose computers) such as shown in FIG. 7. Each unit 101 may interact with other, typically similar units 101, to perform steps according to the present methods.

In exemplary embodiments, in terms of hardware architecture, as shown in FIG. 7, each unit 101 includes at least one processor 105, and a memory 110 coupled to a memory controller 115. Several processors (CPUs, and/or GPUs) may be involved in each unit 101. To that aim, each CPU/GPU may be assigned a respective memory controller.

One or more input and/or output (I/O) devices 145, 150, 155 (or peripherals) are communicatively coupled via a local input/output controller 135. The I/O controller 135 can be coupled to or include one or more buses and a system bus 140, as known in the art. I/O controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

Processor 105 is one or more hardware devices for executing commands, including instructions such as coming as part of computerized tasks triggered by machine learning algorithms. Processors 105 can be any custom made or commercially available processor(s). In general, they may involve any type of semiconductor-based microprocessor (in the form of a microchip or chip set), or more generally any device for executing software instructions, including quantum processing devices.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 7, instructions loaded in the memory 110 may include instructions arising from the execution of the computerized methods described herein in accordance with exemplary embodiments. The memory 110 may further load a suitable operating system (OS). OS controls the execution of other computer programs or instructions and provides scheduling, I/O control, file and data management, memory management, and communication control and related services.

Possibly, a conventional keyboard and mouse can be coupled to the I/O controller 135. Other I/O devices 140-155 may be included. The computerized unit 101 can further include a display controller 125 coupled to a display 130. The computerized unit 101 may also include a network interface or transceiver 160 for coupling to a network (not shown), to enable, in turn, data communication to/from other, external components, e.g., other units 101.

The network transmits and receives data between a given unit 101 and other devices 101. The network may possibly be implemented in a wireless fashion, e.g., using wireless protocols and technologies, such as Wifi, WiMax, etc. The network may be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

The present invention may be a method, and/or a computer program product. The computer program product may include a computer readable storage medium (or media) having computer readable program instructions thereon for causing processors to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Java, Go, Python, Ruby, Scala, Swift, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure refers to embodiments involving cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

While the present invention has been described with reference to a limited number of embodiments, variants and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method for predicting a state of a test entity, the method comprising:
providing, by a processor, a test graph, wherein:
the test graph corresponds to a test entity; and
the test graph has a hybrid structure comprising a static graph that includes a reference vertex associated with an entity, and a dynamic graph connected to the reference vertex;
applying, by the processor, the test graph to a conditional generative model, wherein the conditional generative model has a graph neural network structure; and
predicting, by the processor, a first chronological state for the test graph based on the application of the test graph to the conditional generative model.

2. The computer-implemented method of claim 1, further comprising:
accessing, by the processor, one or more speculative transient attributes;
applying, by the processor, the one or more speculative transient attributes and the test graph to the conditional generative model; and
predicting, by the processor, a second chronological state for the test graph.

3. The computer implemented method of claim 2, wherein predicting a second chronological state further comprises:
predicting, by the processor, a second chronological vertex associated with at least one of the one or more speculative transient attributes.

4. The computer implemented method of claim 2, further comprising:
accessing, by the processor, a modified version of the one or more speculative transient attributes; and
determining, by the processor, the second chronological state of the test graph based on the modified version of the one or more speculative transient attributes.

5. The computer-implemented method of claim 4, further comprising:
analyzing, by the processor, the second chronological state; and
determining, by the processor, an outcome for the second chronological state, based on the analysis of the second chronological state.

6. The computer-implemented method of claim 1, further comprising:
adding, by the processor, one or more actual chronological vertices associated with transient actual properties; and
ordering, by the processor, the added vertices chronologically via oriented chronological edges, with respect to a most recent one of the chronological vertices of the test graph.

7. The computer-implemented method of claim 1, further comprising:
training, by the processor, the conditional generative model on the set of training graphs to learn the temporal evolutions of chronological states of the training graphs.

8. The computer-implemented method according to claim 6, wherein training further comprises:
imposing, by the processor, a loss function to a predetermined minimal smoothness of time variations for the predicted states.

9. The computer-implemented method of claim 6, wherein:
the conditional generative model is implemented as a variational autoencoder by the graph neural network, the latter including two input channels consisting of a first input channel and a second input channel; and
each graph of the training graphs spans a full chronological sequence decomposing into two contiguous chronological sequences, including a first sequence followed by a second sequence.

10. The computer implemented method of claim 6, wherein training the model on the set of training graphs further comprises: comprises:
extracting, by the processor, a first data from the chronological vertices and the associated transient attributes corresponding to the first sequence;
extracting, by the processor, a second data from the sole transient attributes associated with the chronological vertices corresponding to the second sequence; and
inputting, by the processor, the first data into a first input channel and the second data into a second input channel extracted, respectively, for the variational autoencoder to learn to reconstruct a representation of said each graph.

11. The computer-implemented method according to claim 8, wherein:
the variational autoencoder includes an encoder and a decoder;
the encoder is designed to encode input data in a latent space representation in an inner layer block, while the decoder is designed to decode data from the inner layer block; and
the first input channel connects to the encoder, while the second channel connects to the inner layer block.

12. A computer system for predicting a state of a test entity, the system comprising:
one or more computer processors;
one or more computer readable storage devices; and
computer program instructions to:
provide a test graph, wherein:
the test graph corresponds to a test entity; and
the test graph has a hybrid structure comprising a static graph that includes a reference vertex associated with an entity, and a dynamic graph connected to the reference vertex;
apply the test graph to a conditional generative model, wherein the conditional generative model has a graph neural network structure; and
predict a first chronological state for the test graph based on the application of the test graph to the conditional generative model.

13. The computer system of claim 12, further comprising instructions to:
access one or more speculative transient attributes;
apply the one or more speculative transient attributes and the test graph to the conditional generative model; and
predict a second chronological state for the test graph.

14. The computer system of claim 13, wherein predicting a second chronological state further comprises:
predict a second chronological vertex associated with at least one of the one or more speculative transient attributes.

15. The computer system of claim 13, further comprising instructions to:
access a modified version of the one or more speculative transient attributes; and
determine the second chronological state of the test graph based on the modified version of the one or more speculative transient attributes.

16. The computer system of claim 12, further comprising instructions to:
add one or more actual chronological vertices associated with transient actual properties; and
order the added vertices chronologically via oriented chronological edges, with respect to a most recent one of the chronological vertices of the test graph.

17. A computer program product for predicting a state of a test entity, the computer program product comprising:
a computer readable storage medium having program instructions embodied therewith, the program instructions executable by a processor to cause the processors to perform a function, the function comprising:
provide a test graph, wherein:
the test graph corresponds to a test entity; and
the test graph has a hybrid structure comprising a static graph that includes a reference vertex associated with an entity, and a dynamic graph connected to the reference vertex;
apply the test graph to a conditional generative model, wherein the conditional generative model has a graph neural network structure; and
predict a first chronological state for the test graph based on the application of the test graph to the conditional generative model.

18. The computer program product of claim 17, further comprising instructions to:
access one or more speculative transient attributes;
apply the one or more speculative transient attributes and the test graph to the conditional generative model; and
predict a second chronological state for the test graph.

19. The computer program product of claim 18, wherein predicting a second chronological state further comprises:
predict a second chronological vertex associated with at least one of the one or more speculative transient attributes.

20. The computer program product of claim 18, further comprising instructions to:
access a modified version of the one or more speculative transient attributes; and
determine the second chronological state of the test graph based on the modified version of the one or more speculative transient attributes.
